(19) United States
(12) Patent Application Publication
(10) Pub. No.: US 2009/0082918 A1
(43) Pub. Date: Mar. 26, 2009

(54) Motions Dynamics Recorder

(76) Inventor: James Edward Hendrix, JR., Oxford, MS (US)

Correspondence Address: Law Office of MICHAEL D. EISENBERG;Intellectual Property Law, 3263 CAMINITO EASTBLUFF, Suite 198, LA JOLLA, CA, 92037, US

(21) Appl. No.: 12/238,136

(22) Filed: Sep. 25, 2008

Related U.S. Application Data
(60) Provisional application No. 60/995,044, filed on Sep. 25, 2007.

(51) Int. Cl. G06F 7/00

(52) U.S. Cl. 701/33; 701/35

(57) ABSTRACT

A motion dynamics recorder is provided, including a controller; a sensor array in communication with the controller, and configured for measuring at least one characteristic of the motion of a vehicle and/or its systems and environment; a memory module slot for receiving a removable, local memory module; and an optional, distal crash resistant case containing a remote memory module; wherein the controller is configured to generate data from the measurements and to write the data to the removable, local memory module, when the removable memory module is inserted in the slot, and/or the optional remote memory module.

### CROSS-REFERENCE TO RELATED APPLICATIONS

This application claims priority from U.S. Provisional Application Ser. No. 60/995,044 filed Sep. 25, 2007 which is hereby incorporated herein by reference in its entirety.

### TECHNICAL FIELD

The present invention, in some embodiments thereof, relates to flight data recorders, and more particularly, some embodiments relate to motion recorders for vehicles, such as aircraft.

### BACKGROUND OF THE INVENTION

In aviation, flight data recorders are used to record specific aircraft system and performance parameters. Flight data recorders are also known as “black boxes” and are useful for investigation of aircraft accidents. However, flight data recorders are also employed in the study of air safety issues, material degradation, and jet engine performance.

### BRIEF SUMMARY OF EMBODIMENTS OF THE INVENTION

An aspect of the present invention relates to a motion dynamics recorder, including a controller; a sensor array in communication with the controller, and configured for measuring at least one characteristic of the motion of a vehicle; and a memory module slot for receiving a removable local memory module; wherein the controller is configured to generate data from the measurements and to write the data to a removable memory module, when the removable memory module is inserted in the slot.

Optionally, the sensor array is further configured for measuring at least one characteristic of the environment of the vehicle.

Optionally, the motion dynamics recorder further includes a local housing for supporting the sensor array, the controller and the local memory module; a remote housing located distal to the local housing; and a remote memory module disposed in the remote housing and in communication with the controller; and the controller is configured to write at least some or all of the data to the local memory module and at least some or all of the data to the remote memory module.

Optionally, the memory module slot is further configured to receive a setup module containing setup data, and the controller is configured to read the setup data and reconfigure at least one operation of the motion dynamics recorder according to the setup data.

Optionally, the remote housing is a crash resistant case.

Optionally, the memory module is readable by a computing unit having user interface software, and the user interface software grants or denies access to data in the module to a user, according to an access permission scheme.

Optionally, each memory module is individually assignable to a combination of users, the users including at least an owner and optionally an instructor, and/or an operator; the user data including owner identification data containing a name and password, optionally instructor identification data containing a name and password, and optionally operator data containing a name and password. The access permission scheme is based on the user data such that:

an operator using the computing unit's user interface software is granted access only to logs that carry that operator's data, providing the operator has provided the proper password to the user interface;

an instructor using the computing unit's user interface software is granted access only to logs that carry that instructor's data, either as instructor or operator, providing the instructor has provided the proper password to the user interface; and

an owner using the computing unit's user interface software is granted access to all logs, providing the owner has provided the proper password to the user interface.

Optionally, the motion dynamics recorder further includes a port for connecting to an audio and/or visual display device, and the motion dynamics recorder is configured to output at least some of the data to the audio and/or visual display device in real-time.

Optionally, the motion dynamics recorder is configured to stream the data to an external device while the motion dynamics recorder is performing one or more of the following operations: measuring motion, generating data, and writing data to the memory module.

Optionally, the motion dynamics recorder is further configured to stream data to the external device while the motion dynamics recorder measures and generates data; the motion dynamics recorder streams data to the external device, with or without the local memory module inserted into the slot; and motion dynamics recorder streams data to the external device, with or without the remote memory module in communication with the recorder.

Optionally, the motion dynamics recorder is configured to operate within a vehicle including a switched power bus and an unswitched power bus, and the motion dynamics recorder further includes two power sources, the two power sources including a switched power input connectable to the vehicle's switched power bus. and a backup power input connectable to a charge storage device connected to the vehicle's unswitched power bus. The motion dynamics recorder is configured to draw power from the backup input when power from the switched power input is turned off while the motion dynamics recorder has open logs receiving data.

Optionally, the motion dynamics recorder is configured to automatically shut down when the vehicle main power is off, except the motion dynamics recorder is configured to remain on and draw power from the backup power input if the motion dynamics recorder is in the process of writing data to open logs on one or more memory modules and to shut off the backup power and shut down the motion dynamics recorder when the motion dynamics recorder closes the last open log.

Another aspect of the present invention relates to a system for recording vehicle data logs and associating vehicle data logs with one or more personnel operating the vehicle. The system includes one or more local memory modules, each configured with user identification data indicative of personnel in the vehicle, a vehicle data recorder, including a memory module slot configured to receive at least one local memory module. The vehicle data recorder is configured to write and store a log containing vehicle data to the memory modules; and the system is configured to copy the user identification data from local memory module to the log, thereby identifying individual logs with the users of the vehicle.

Optionally, the above system, further includes:

a first housing for supporting the vehicle data recorder and a local memory module;

a remote housing located distal to the first housing; and

a remote memory module disposed in the remote housing and in communication with the vehicle data recorder.

The system is configured to copy the user identification data from the local memory module to both the local and remote logs, and the system is configured to copy user identification data from the remote memory module to both the local and remote logs, thereby identifying individual logs to users of the vehicle.

Optionally, the local memory module is assignable to a combination of users, the combination including one vehicle owner, optionally an instructor, and optionally an operator, by means of a specific password for each user;

the operator is provided with an operator password, which allows the operator to access logs which contain the operator's identification data;

the instructor is provided an instructor password, which allows the instructor to access logs which contain the instructor's identification data; and

the owner is provided with an owner password, which allows the owner to access all logs.

Optionally, the memory modules necessarily contain the owner's identification data, may contain an operator's identification data, and may contain an instructor's identification data.

Optionally, the motion dynamics recorder is configured to generate motion tracking data, the sensor array of the motion dynamics recorder further including an inertial tracking module for tracking the vehicle's motion using the laws of inertia, and a satellite based tracking module for tracking the vehicle's motion using a satellite positioning system.

Optionally, the tracking data includes an inertial motion track based on a measurement from the inertial tracking module, and a satellite based motion track based on a measurement from the satellite based tracking module. The two motion tracks are weighted with weighting factors and combined into a single combined data track. The weighting factor for the inertial motion track increases as the satellite based component becomes less accurate than the inertial motion track, and the weight factor for the satellite based component increases as the inertial motion track becomes less accurate than the satellite based motion track.

Optionally, the sensor array includes:

a set of low range accelerometers with high resolution for taking acceleration measurements along at least one of the vehicle's axes when the acceleration of the vehicle along the axis is below a specific threshold; and

a set of high range accelerometers with low resolution for taking acceleration measurements along at least one of the vehicle's three axes when the acceleration of the vehicle along the axis is over the threshold.

Optionally, each set of accelerometers includes three accelerometers for taking acceleration measurements along the vehicle's three axes, each accelerometer operating independently of the others.

Optionally, the motion dynamics recorder is configured for writing the data at a variable data logging rate.

Optionally, the motion dynamics recorder is configured to:

increase the data logging rate when the motion dynamics recorder senses that the vehicle is maneuvering, to provide data which describes the vehicle's motion at a greater resolution; and

decrease the data logging rate when the motion dynamics recorder senses that the vehicle is not maneuvering, for conserving storage space on the local memory module.

Optionally, the local memory module is hot swappable with other memory modules during operation of the motion dynamics recorder.

Optionally, the motion dynamics recorder is configured to write the data to a single file on the memory module, and the file occupies the total storage capacity of the memory module.

Optionally, the motion dynamics recorder is configured to write the data to the file on the memory module in a serial manner. The data is organized in a serial manner and returns from the end of the file to the beginning in a cyclical manner with individual motion logs juxtaposed and contiguously arranged.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

Some of the figures included herein illustrate various embodiments of the invention from different viewing angles. Although the accompanying descriptive text may refer to such views as “top,” “bottom” or “side” views, such references are merely descriptive and do not imply or require that the invention be implemented or used in a particular spatial orientation unless explicitly stated otherwise.

FIG. 1 is an exemplary drawing of a self-contained motion dynamics recorder according to some embodiments of the invention;

FIG. 2 is a schematic drawing illustrating a motion dynamics recorder, according to some embodiments of the present invention;

FIG. 3 is a schematic drawing illustrating a motion dynamics recorder featuring a remote memory, according to some embodiments of the present invention;

FIG. 4 is a schematic drawing illustrating a motion dynamics recorder configured to receive a setup module, to configure the operations of the motion dynamics recorder, according to some embodiments of the present invention;

FIG. 5 is a schematic drawing illustrating a computing unit operable with the memory modules written on by the motion dynamics recorder and the setup module used to configure the motion dynamics recorder, according to some embodiments of the present invention;

FIG. 6 is a schematic drawing illustrating the format of a memory module, according to some embodiments of the present invention;

FIG. 7 is a schematic drawing illustrating a motion dynamics recorder including a data port for streaming data to an external device, according to some embodiments of the present invention;

FIG. 8 is a schematic drawing illustrating a motion dynamics recorder connected to a vehicle's switched power bus, and to a charge storage device stored in the vehicle's unswitched power bus, according to some embodiments of the present invention;

FIG. 9 is a schematic drawing illustrating a motion dynamics recorder, which includes an inertial tracking module and a satellite based tracking module as part of the sensor array, according to some embodiments of the present invention;

FIG. 10 is a schematic drawing illustrating a motion dynamics recorder which includes a set of low range accelerometers and a set of high range accelerometers as part of the sensor array, according to some embodiments of the present invention;

FIG. 11 is flowchart illustrating a method for writing encrypted data on a memory module, according to some embodiments of the present invention.

FIG. 12 is a flowchart illustrating a method for acquiring at least one characteristic of the motion of a vehicle and/or at least one characteristic of the environment outside the vehicle, according to some embodiments of the present invention.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENT OF THE INVENTION

From time-to-time, the present invention is described herein in terms of example environments. Description in terms of these environments is provided to allow the various features and embodiments of the invention to be portrayed in the context of an exemplary application. After reading this description, it will become apparent to one of ordinary skill in the art how the invention can be implemented in different and alternative environments.

Unless defined otherwise, all technical and scientific terms used herein have the same meaning as is commonly understood by one of ordinary skill in the art to which this invention belongs. All patents, applications, published applications and other publications referred to herein are incorporated by reference in their entirety. If a definition set forth in this section is contrary to or otherwise inconsistent with a definition set forth in applications, published applications and other publications that are herein incorporated by reference, the definition set forth in this document prevails over the definition that is incorporated herein by reference.

Before describing aspects of the present invention, a few important terms are to be defined. The term “log data record” herein refers to data generated from a measurement taken at a specific time by a specific sensor or set of sensors and written on a memory module. The term “log” refers to a storage area in which data records are written at selected time intervals on a memory module during a period between the opening and closing of the log. An “open log” is a log that is ready to be written upon. A “closed log” is a log which is not ready to receive data records.

The present invention relates to flight data recorders, and more particularly, some embodiments relate to motion recorders for vehicles, such as aircraft.

An aspect of the present invention relates to a motion dynamics recorder, which features a memory module slot configured to receive a local memory module carried by a vehicle operator. The motion dynamics recorder measures at least one characteristic of the motion of the vehicle and optionally at least one characteristic of the environment inside and/or outside the vehicle, and writes data generated by the above measurements on the local memory module inserted into the slot. The local memory module may be ejected from the slot and inserted into a computing unit, where the data may be analyzed, through appropriate software. Optionally, the motion dynamics recorder is designed also for streaming the data to an external device, such as an electronic motion information system.

In a variant, the above motion dynamics recorder includes a first housing, which contains a slot for an optional local memory module, and optionally further includes a remote housing, which holds a remote memory module. The data may be written on either or both the local memory module and the remote memory module. The data may be written on the local and remote memory modules in various alternative combinations. For example, data may be written simultaneously to both modules with less data written on the remote module than on the local module or exactly the same data or more data written on the remote module. Optionally, the remote housing is a crash resistant case. Thus, though the local memory module may be lost in the event of a vehicle crash, the remote memory module may be recovered.

Optionally, the slot of the motion dynamics recorder further receives a setup module. The motion dynamics recorder is operable for reconfiguring one or more operations of the motion dynamics recorder, for example a writing operation or a measuring operation, according to the data contained in the setup module.

An aspect of the present invention relates to a memory module used in conjunction with the above motion dynamics recorder. The memory module features three storage areas. A first storage area contains setup variables and storage allocation variables. A second storage area contains numerous operational parameters as well as user information, such as a name and a password of at least one user. A third storage area contains data from the measurements performed by the motion dynamics recorder, arranged in individual logs representing periods of vehicle motion. In a variant, first, second and second storage areas are contained within a single file. Optionally, the file is encrypted during writing by the motion dynamics recorder. In such a case, the encrypted data is decrypted when the memory module is inserted into a computing unit. The specific logs that are read and decrypted depends upon whether or not the user of the computing unit was also identified in the log when the log was recorded.

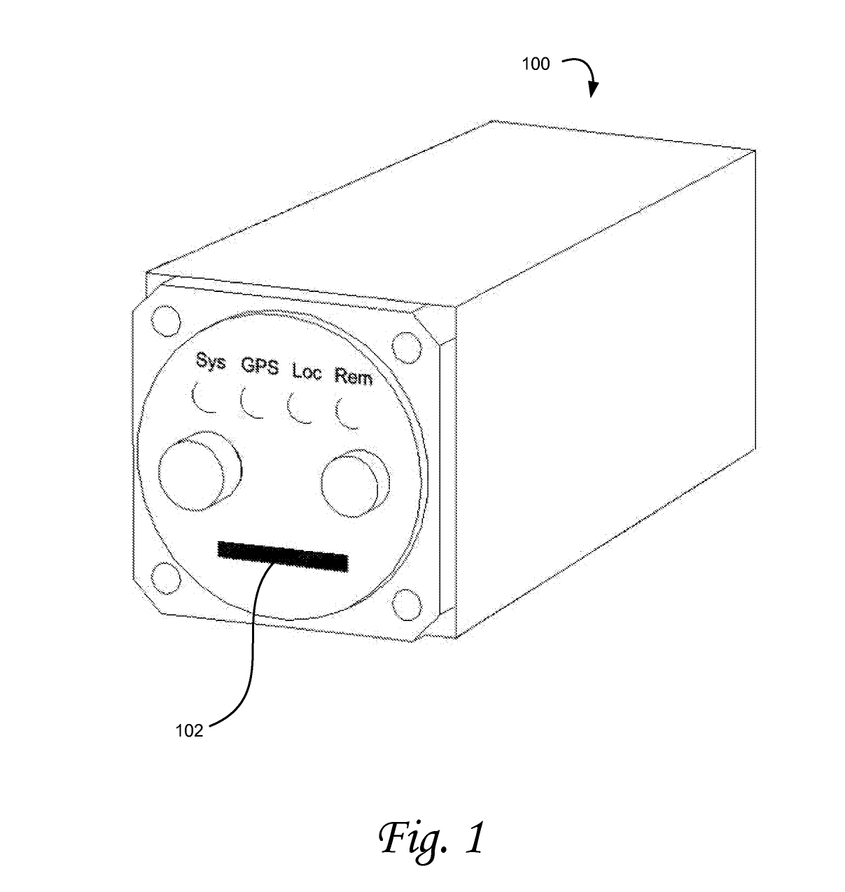

FIG. 1 is an exemplary drawing of a self-contained motion dynamics recorder according to some embodiments of the invention. The motion dynamics recorder 100 includes a housing, which houses components of the motion dynamics recorder 100 (presented later). The motion dynamics recorder 100 is characterized by a slot 102 designed to receive a local memory module carried by a user, so that the motion dynamics recorder 100 can write data on the local memory module. According to some embodiments of the present invention, the motion dynamics recorder 100 is low-weight, and easily installable on a vehicle. According to an exemplary embodiment, the motion dynamics recorder 100 weighs about 14 ounces and mounts into a 2.25-inch instrument hole of an aircraft. It is important to note that though the motion dynamics recorder 100 may be hereafter presented in relation to an aircraft, the motion dynamics recorder 100 may be mounted in any vehicle, for example a car or a boat.

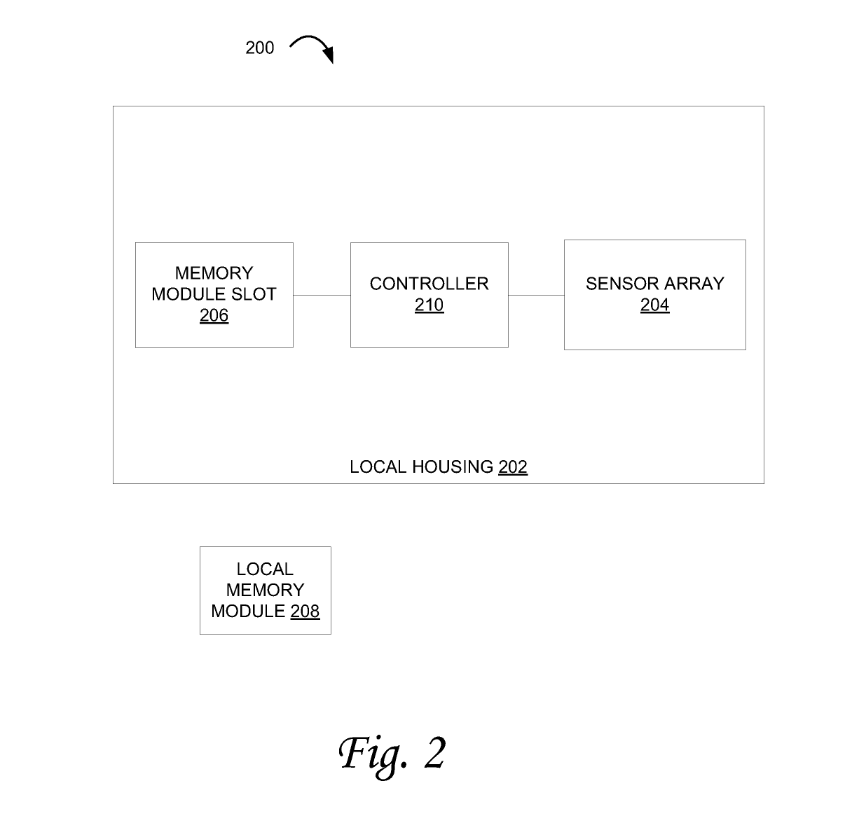

FIG. 2 is a schematic drawing illustrating a motion dynamics recorder, according to some embodiments of the present invention. The motion dynamics recorder 200 includes a housing 202, for containing components of motion dynamics recorder 200; sensor array 204, for measuring at least one characteristic of the motion of the vehicle and optionally at least one characteristic of the environment outside the vehicle; a memory module slot 206, for receiving a local memory module 208; and a controller 210, for receiving measurements from the sensor array 204 and writing the measurements as data onto the memory module 208.

In a variant, the sensor array 204 includes one, several, or any combination of one or more of the following: a satellite based tracking device (for example a global positioning service (GPS) device) for measuring time, and tracking the latitude, longitude, altitude, and ground speed of the aircraft; one or more pressure sensors, to measure the pressure inside the vehicle and/or Pitot and static pressures outside the vehicle; a set of accelerometers, to measure the accelerations of the vehicle; a set of rotation sensors (for example, a gyroscope), for measuring the rotation rates of the vehicle; and an outside-air-temperature probe, for measuring the temperature of the air outside the vehicle. More kinds of sensors may be added, as deemed necessary by a user.

The set of accelerometers may include one or more accelerometers. According to some exemplary embodiments of the present invention, three accelerometers are included in the set, for measuring accelerations on each of three Cartesian axes. The set of rotation sensors may include one or more rotation sensors. According to some exemplary embodiments of the present invention, three rotation sensors are included in the set, for measuring rotation rates around each of three Cartesian axes.

In another variant, the motion dynamics recorder 200 further includes a port for connecting to a visual display device, and is designed to output at least some of the data to the visual display device in real-time. For example, the visual display device may present a moving map for navigation purposes, or it may function as an artificial horizon.

In a further variant, the vehicle's communication transceiver is connected to the motion dynamics recorder 200. The audio signal from the communication transceiver is received by the motion dynamics recorder 200, for example through an audio port (not pictured) and merged with audio signals generated by motion dynamics recorder 200 itself. The merged signal is output to reach the vehicle operator, for example through headphones. For example, the motion dynamics recorder 200 may be designed to emit a warning sound, when the sensor array 204 measures a specific parameter, for example acceleration, which has crossed over a specific threshold. The warning sound may alert the vehicle operator or operators of upcoming danger, so that they can act accordingly. Audio signals generated by the motion dynamics recorder may be warning tones or verbal information relating to vehicle performance.

In yet another variant, the local memory module 208 is a solid-state memory module, such a Secure Digital (SD) card, or a Universal Serial Bus (USB) mass-storage device (also known as “disk-on-key”). Optionally, the local memory module 208 is an optical memory module, such as a Compact Disc (CD), or Digital Versatile Disc (DVD). Optionally, the local memory module 208 can be taken out of the memory slot 206 while data is being written upon the local memory module 208, without causing damage to either motion dynamics recorder 200, or to local memory module 208. Consequently, a second local memory module may be inserted into the memory slot 206, and written upon. A memory module as just described will be hereafter called a “hot-swappable” memory module.

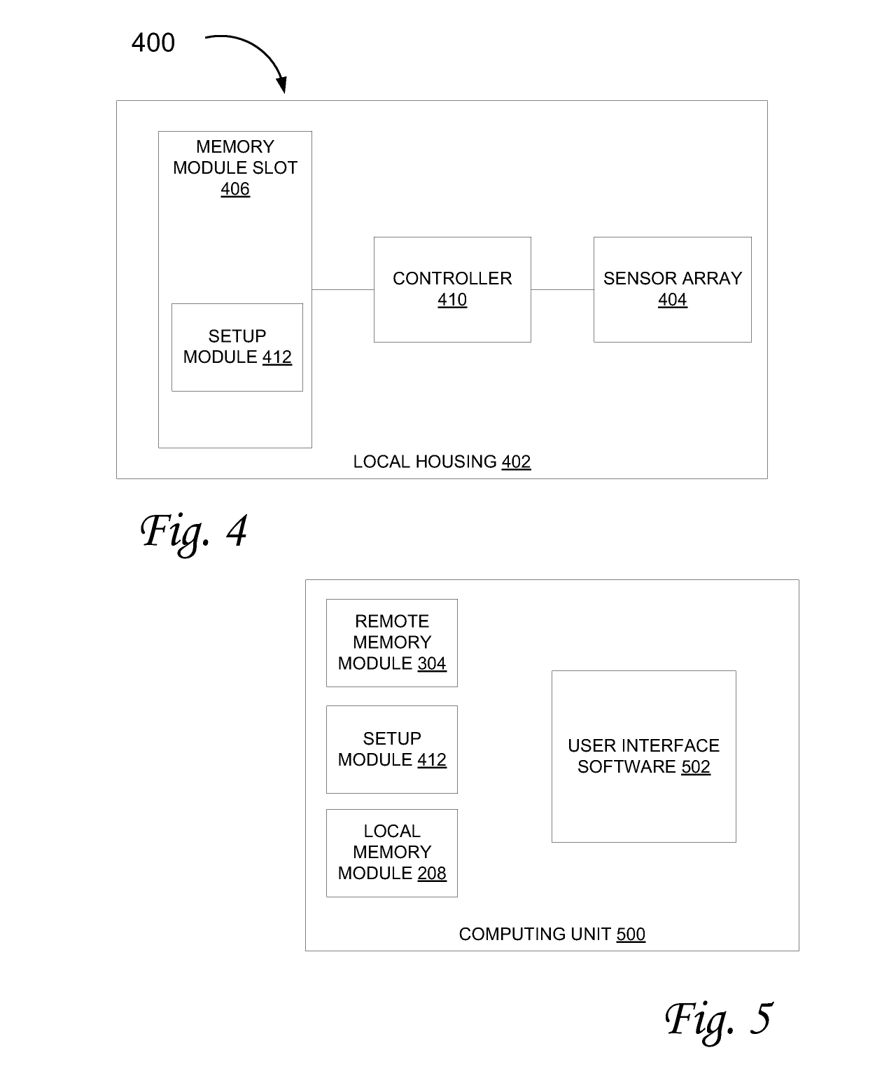

In still a further embodiment, the controller 210 operates, according to user instructions. Operation of controller 210 includes generating data from measurements, writing data to one or more memory modules, streaming data to external devices, and accomplishing any of the functions defined in this document, User instructions may be stored in a setup module, which may be inserted in the memory module slot 206 and read by the controller 210, as will be explained later, in the description of FIG. 4. Optionally, the motion dynamics recorder 200 also includes a user interface (not pictured), such as a keypad, in communication with the controller 210, to receive instructions from a user. Optionally, the motion dynamics recorder 200 includes an input port (not pictured), that may be connected to a user interface of choice, for example a palm pilot, desktop computer or a laptop computer. Optionally, the input port is the same as the port described above, for connecting a visual device. The input port is in communication with the controller 210. Optionally, communication between the user interface and controller 210 or the input port and controller 210 is electrical, for example through an electrical cable.

In another variant, the controller 210 writes data on the local memory module 208 at a variable logging rate. The logging rate refers to the frequency at which a data record is written by the controller 210 into a log. Data written at a higher logging rate describes the motion of the vehicle with a greater resolution, and occupies more storage space on memory modules. Data written at a lower logging rate describes the motion of vehicle at a lower resolution, but occupies less storage space on the memory modules. According to an exemplary embodiment of the present invention relating to the flight of an aircraft, a high logging rate is of about 10 Hertz (0.1 seconds per data instance), and a low logging rate is of about 0.5 Hertz.

In a further variant, the logging rate is set by a user, according to the methods described above. Optionally, the motion dynamics recorder 200 is designed to increase the logging rate, when the sensor array 204 determines that the vehicle is maneuvering, in order to provide a description of motion at a greater resolution for detecting changes in velocity. Optionally, the motion dynamics recorder 200 is designed to decrease the logging rate, when sensor array 204 senses that the vehicle is not maneuvering, in order to conserve storage space, since the position of the vehicle can be calculated more accurately when the motion of the vehicle is linear. Values of certain parameters, for example acceleration and rotation, measured by the sensor array define whether a vehicle is in a maneuvering state or in a non-maneuvering state. The values may be set by the manufacturer of the motion dynamics recorder 200, or by a user, according to the reconfiguration methods described above.

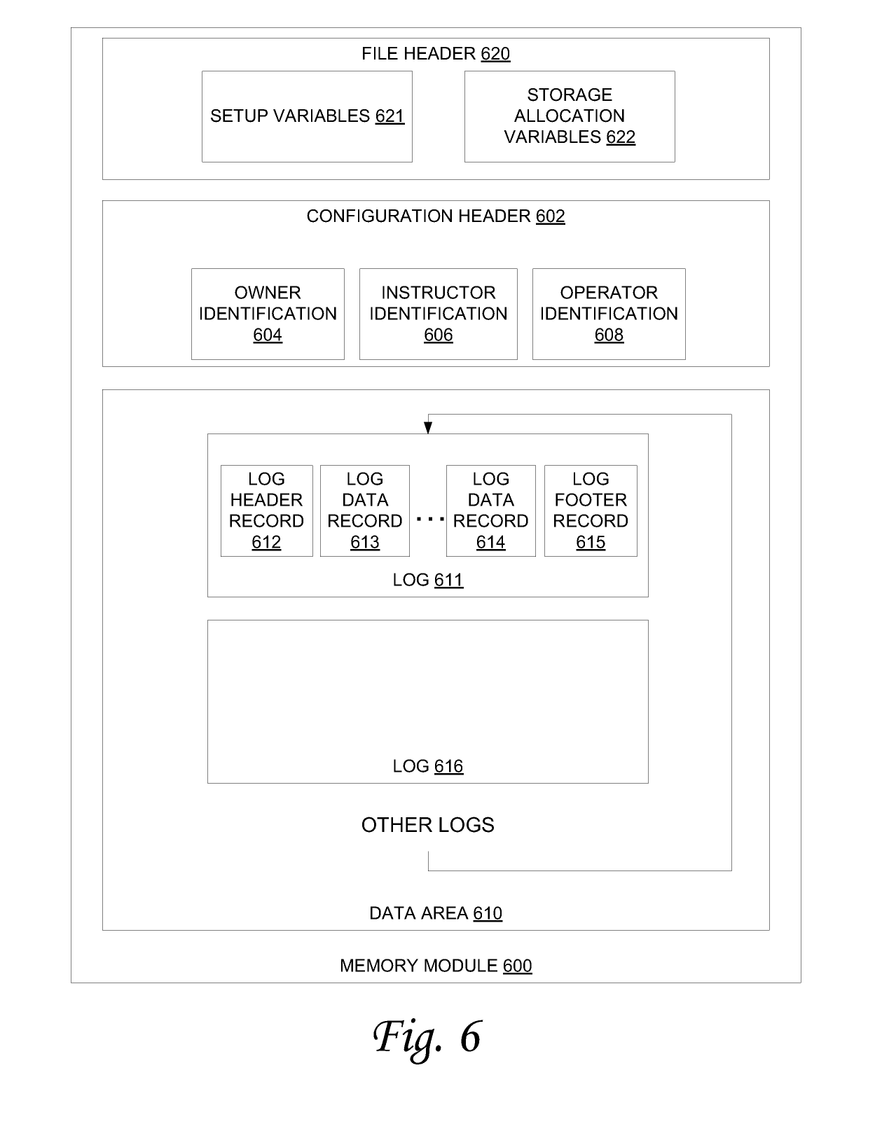

In still another variant, as the controller 210 writes data on the local memory module 208, the controller 210 encodes the data. Access to specific logs on the local memory module depends upon whether or not the user of the computing unit is also identified in the log when the log was recorded, as explained later in the description of FIG. 6.

In yet a further variant, the controller 210 includes a non-removable buffer memory (for example static random access memory—SRAM), to which the data is written and held temporarily before being moved to the local memory module 208. Optionally, the buffer is the size of a page on the local memory module (for example, 512 bytes). After the buffer memory accumulates a page of data, the data is moved to the local memory module. The buffer memory is then considered to be empty and ready to receive more data. Furthermore, when a loss of operation of the motion dynamics recorder occurs (power outage, for example), only the data in the buffer memory is lost.

In another variant, a user may specify the frequency at which the data is copied from the buffer memory to the local memory module 208. This may be accomplished by partially filling buffer memory pages before copying the partially filled memory pages to the local memory module. This procedure is called “buffer flushing”. Buffer flushing is useful in case the motion dynamics recorder 200 should become inoperative, as the amount of data lost because of the loss of operation of motion dynamics recorder 200 is reduced. Optionally, the buffer flushing frequency selection is different for each memory module, and is specified by the user to which the memory module is assigned. For example, according to an exemplary embodiment of the current invention, the interval at which the data is moved from the buffer memory to the local memory module 208 may be chosen to be any multiple of 0.1 seconds. For example, 0.2 seconds, 0.4 seconds, 3.7 seconds. Optionally, regardless of the buffer flushing interval specified, the buffer memory is always copied to the local memory module whenever the buffer memory contains a full page of data. A shorter buffer flushing interval reduces the data loss caused by a loss of operation of the motion dynamics recorder 200. A longer buffer flushing interval reduces the processing demand on the controller 210, thereby reducing the likelihood of data loss due to data overrun. Furthermore, a longer buffer flushing interval may increase the longevity of the local memory module 208, as pages on the local memory module are not rewritten repeatedly until they become full.

In a further variant, the motion dynamics recorder 200 is designed to automatically increase the frequency at which data is flushed from the buffer memory, when vehicle maneuvering is sensed. Such a property of the motion dynamics recorder 200 may limit the data loss that may be caused by an abrupt loss of operation of the motion dynamics recorder 200 when the vehicle is maneuvering of the vehicle. According to some embodiments of the present invention, the sensor array 204 detects maneuvering when at least one of the measured quantities crosses a threshold, and instructs the controller 210 to increase the frequency at which data is flushed from the buffer memory to the local memory module 208. Optionally, the threshold is set during the manufacturing of the motion dynamics recorder 200. Optionally, the threshold may be set by a user, through devices described above.

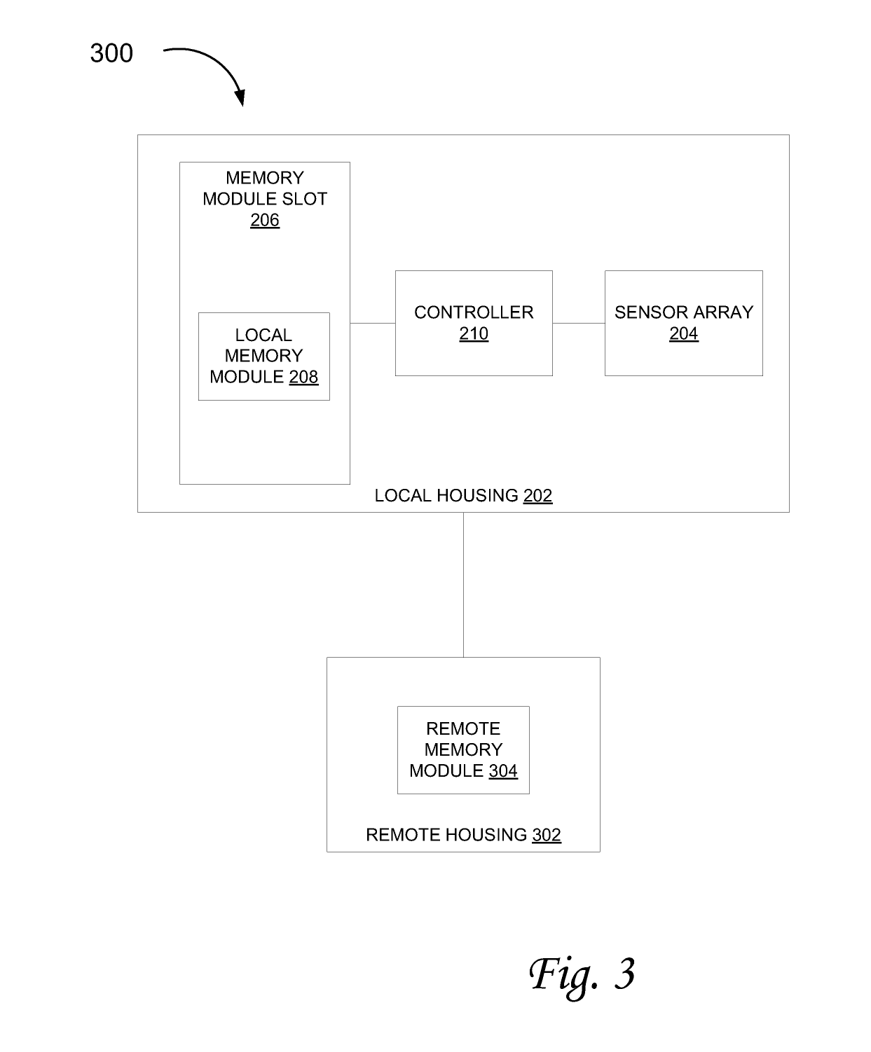

FIG. 3 is a schematic drawing illustrating a motion dynamics recorder featuring a remote memory module, according to some embodiments of the present invention. The motion dynamics recorder 300 includes the same components of the motion dynamics recorder 200 of FIG. 2. In addition, the motion dynamics recorder 300 includes a remote housing 302, placed distal from local housing 202. The remote housing 302 houses a remote memory module 304. The remote memory module 304 is in communication with the controller 210, so that the controller 210 writes data on the remote memory module 304.

In some embodiments of the present invention, the remote memory module 304 is structured the same as the local memory module 208, as shown in FIG. 6, and functions in the same manner. According to some embodiments of the present invention, configuration data in each memory module determines which data is written to that memory module, the frequency at which the data are acquired, and the frequency at which data records are written. Thus, local memory module 208 and remote memory module 304 may contain the same data or different data. Either memory module may serve as a backup for the other. The local memory module is normally used for private operator use.

In a variant, the remote memory module 304 is configured to record all vehicle motion, regardless of whether a local memory module 208 is present. Therefore, the remote memory module may be assigned to be used by the vehicle owner.

In still another variant, the remote housing 302 includes a crash resistant case, and is designed to protect the remote memory module 304 in the event of a vehicle crash. A remote memory module 304 protected by a crash resistant case may be recovered after a vehicle crash, and the data in the remote memory module 304 may be used to investigate the causes of the crash. Optionally, the remote housing 302 is the only crash resistant component of motion dynamics recorder 300. By crash protecting only remote memory module 304 and not the whole motion dynamics recorder 300, the cost of the motion dynamics recorder 300 may be reduced. Furthermore, the size and weight of the motion dynamics recorder 300 may be reduced as well, making the motion dynamic recorder 300 compatible with the strict weight-and-balance requirements of light aircraft such as unmanned aerial vehicles (UAVs), light aircraft and gliders. According to an exemplary embodiment of the present invention, the crash resistant remote housing 302 and remote memory module 304 weigh 7 ounces, and the dimensions of the housing are 3.75 inches×2.28 inches×1.47 inches.

In yet a further variant, if the local memory module 208 is hot-swappable, the act of swapping local memory modules is recorded on the remote memory module 304. For example, if a pilot and an instructor are in an airplane, and each has a local memory module, the pilot operating the airplane inserts the pilot's local memory module into the memory slot 206 when piloting the airplane. At some point during the flight, the instructor takes over the control of the airplane, ejects the pilot's local memory module and inserts the instructor's memory module into the memory slot 206. The swapping of local memory modules is recorded on the remote module 304. This may be useful for identifying from the data who piloted the airplane at a given time.

In another variant, the motion dynamics recorder 300 is designed to be able to copy data logs from the remote memory module 304 to the local memory module 208. Copying logs from the remote memory module 304 to the local memory module 208 eliminates the need to gain physical access to the remote memory module 304, which is likely to be installed in a difficult to reach part of the vehicle, such as the tail of an aircraft. Furthermore, this eliminates the need to open the remote housing 302 in order to retrieve the remote memory module 304. Optionally, data logs may also be copied from local memory module 208 to remote memory module 304.

In a further variant, the communication between the controller 210 and the remote memory module 304 is electrical, and the controller 210 and remote memory module 304 are connected by an electrical cable. For example, the controller 210 may be located in the cockpit of an airplane, and connected to the remote memory module 304, which is located in the back of the airplane, through an electrical or a digital transmission cable. Optionally, the communication between controller 210 and remote memory module 304 is wireless, for example through radio frequency (RF) communication devices connected of controller 210 and the remote memory module 304.

FIG. 4 is a schematic drawing illustrating a motion dynamics recorder configured to receive a setup module, to configure the operations of the motion dynamics recorder, according to some embodiments of the present invention. The motion dynamics recorder 400 includes the same components as the motion dynamics recorder 200 of FIG. 2. In addition to receiving the local memory module 208, memory module slot 406 is designed for receiving a setup module 412 as well. The setup module 412 contains setup data, which is read by the controller 410 and supplies the controller 410 with instructions relating to specific operating modes: for example, the instructions may relate to the selection of data that is to be written on the local memory module 208, the logging frequency of data onto any memory module, the buffer flushing interval, and any other functions of the motion dynamics recorder described in this document.

Optionally, the setup module 412 contains firmware updates, which are automatically installed in the motion dynamics recorder 400, when the setup module 412 is inserted into the memory slot 406.

In a variant, the setup module 412 is a local memory module 208. In such a case, the local memory module 208 contains the setup data.

In another variant, the setup data within the setup module 412 may be determined by a user. This may be done, for example, by inserting the setup module 412 into an appropriate slot of a computing unit, and setting parameters, through appropriate user interface software, as described in FIG. 5.

FIG. 5 is a schematic drawing illustrating a computing unit operable with the memory modules written on by the motion dynamics recorder and with the setup module used to configure the motion dynamics recorder, according to some embodiments of the present invention.

In FIG. 5, a computing unit 500 is represented. The computing unit 500 includes a user interface software 502, and is operable with the local memory module 208 of FIG. 2, the remote memory module 304 of FIG. 3, and the setup module 412 of FIG. 4. According to an exemplary embodiment of the present invention, the computing unit 500 is a personal computer, and the user interface software 502 allows a user to operate the memory modules and the setup module. Operation of the memory modules 208 and 304 by a user through the computing unit 500 refers to initializing the memory modules for use by the motion dynamics recorder and copying data logs from the memory modules to files on computing unit 500 storage devices by means of the user interface software 502. Operation of the setup module 412 by a user through the computing unit 500 refers to initializing the setup module with parameters to be stored in non-volatile memory (such as flash memory) within the motion dynamics recorder.

FIG. 6 is a schematic drawing illustrating the format of a memory module, according to some embodiments of the present invention. A memory module 600 initialized for use by a motion dynamics recorder is depicted. The memory module 600 may be used as the local memory module 208 of FIG. 2 and as the remote memory module 304 of FIG. 3. The memory module 600 contains a single file called a “cardfile”. The cardfile contains a file header page 620, where setup variables 621 and storage allocation variables 622 are stored; a configuration header page 602 where user identification information (604, 606 and 608) is stored; and a data area 610 where log data to be written by the motion dynamics recorder is stored.

According to some embodiments of the present invention, data in the data area 610, is organized in logs (611 and 616). An exemplary data log data log 611 includes one log header record 612, one or more log data records (613 and 614) and one log footer record 615, in the order mentioned. Each log describes a continuous period of more or less continuous vehicle motion.

The log header record 612 is written into a log, when a log is opened. The log header record 612 contains user data copied from the configuration header 602. After the log header 612 is written, the log data records 613 and 614 are written by the motion dynamics recorder. Finally, when the motion dynamics recorder stops writing log data records, a log footer record 615 is created to identify the end of the log and to close the log. When the motion dynamics recorder writes new data, a new log 616 is opened. Optionally, logs are opened when the motion dynamics recorder senses vehicle motion, and logs are closed when the motion dynamics recorder senses that the vehicle is not moving.

The inclusion of user identification in the log header 612 allows each log to be assigned to the appropriate users. For example, a first operator inserts a local memory module containing the first operator's identification into the motion dynamics recorder, while the first operator is controlling the vehicle. Logs opened during the time that the first operator is at the controls contain the first operator's identification. A second operator takes the same local memory module, and initializes the local memory card with the second operator identification. Then the second operator assumes control of the vehicle. Logs opened while the second operator controls the vehicle contain the second operator's identification. When the first operator inserts the local memory module into a computing unit 500, the user interface software 502 grants access to the first operator only to logs which contain the first operator's identification in the log header. Similarly, the second operator is granted access only to those logs which contain the second operator's identification in the log header.

File header 620 contains setup variables 621 and storage allocation variables 622. Setup variables 621 include parameters relating to the operation of the motion dynamics recorder, as described above. Setup variables 621 are read by the motion dynamics recorder and are used to reconfigure the motion dynamics recorder to operate according to a user's preference. Storage allocation variables 622 include data describing the position of data logs in the data area 610. Storage allocation variables 622 are read by the motion dynamics recorder, so that the motion dynamics recorder finds space which can be written upon, without erasing valuable data.

In some embodiments of the present invention, user data in the configuration header 620 of a memory module 600 includes one instance of owner identification 604 and optionally an instructor identification 606 and/or an operator identification 608. In a variation of the present invention, an operator may access logs written only while the memory module 600 has that operator's identification in its configuration header 602. An instructor may access logs written only while the memory module 600 has that instructor's identification in its configuration header 602. The vehicle owner may access all logs.

In a variant, instructor and operator identification data may be distributed across memory module configuration headers and are chosen to be copied into log headers when logs are opened. Both local and remote cards carry owner, instructor and operator information in their configuration headers. Remote modules are either permanently attached or attached much longer than local memory modules and therefore are a more reliable source of the owner information than local modules, since foreign (modules of other ownership) local memory modules may be inserted into a recorder slot 206. However, since a remote memory module is generally not changed, local memory modules are the source for instructor and operator information. Thus, when a log is opened, whether local or remote, the owner information is copied from the remote module header; whereas, instructor and operator information is copied from the local module header. If there is no remote module attached, then the owner information comes from the local header. If there is no local module in the slot, then instructor and operator information comes from the remote module as a default. Those fields may be blank, if no defaults are desired. If neither local nor remote modules are present, no log can be opened; however, data streaming can still occur and the instrument may therefore still be useful.

The memory module 600 contains a single file, which contains the format elements described above and is never erased, but rather has its contents changed by the motion dynamics recorder and the computing unit 500. This feature may increase the lifetime of memory module 600, particularly in the case that memory module 600 is a flash memory device, such as an SD card, which normally can write a data page no more than about 100,000 times. In a conventional memory module where files are written and deleted, a specific directory page is used to store the file list. This directory page is written more frequently than the rest of the memory module, when changes are made, and is therefore worn off more quickly. When the directory page is worn off, the memory module becomes unusable. In contrast, the format of the memory module 600 provides a more even distribution of the writing on the memory module, thereby increasing the lifetime of the memory module 600.

When the memory module 600 is initialized, the computing unit 500 writes the configuration header 602, data area 610, and file header 620 with appropriate initial values. When the motion dynamics recorder opens a log on a memory module 600, the motion dynamics recorder uses storage allocation variables 622 in the file header 620 to find the appropriate storage space to use in the data area 610. When the motion dynamics recorder closes a log, the motion dynamics recorder updates the storage allocation variables 622 in the file header 620 to reflect the existence of the log. Optionally, when the end of the data area 610 is reached, additional space is found by returning to the beginning of the data area 610. Old logs are overwritten as necessary. The capacity of a typical 1-gigabyte SD card is large enough to contain a minimum of about 800 hours of data recorded at the fastest possible logging rate. That gives ample time for old logs to be copied to computing unit 500 storage devices before being overwritten by the motion dynamics recorder.

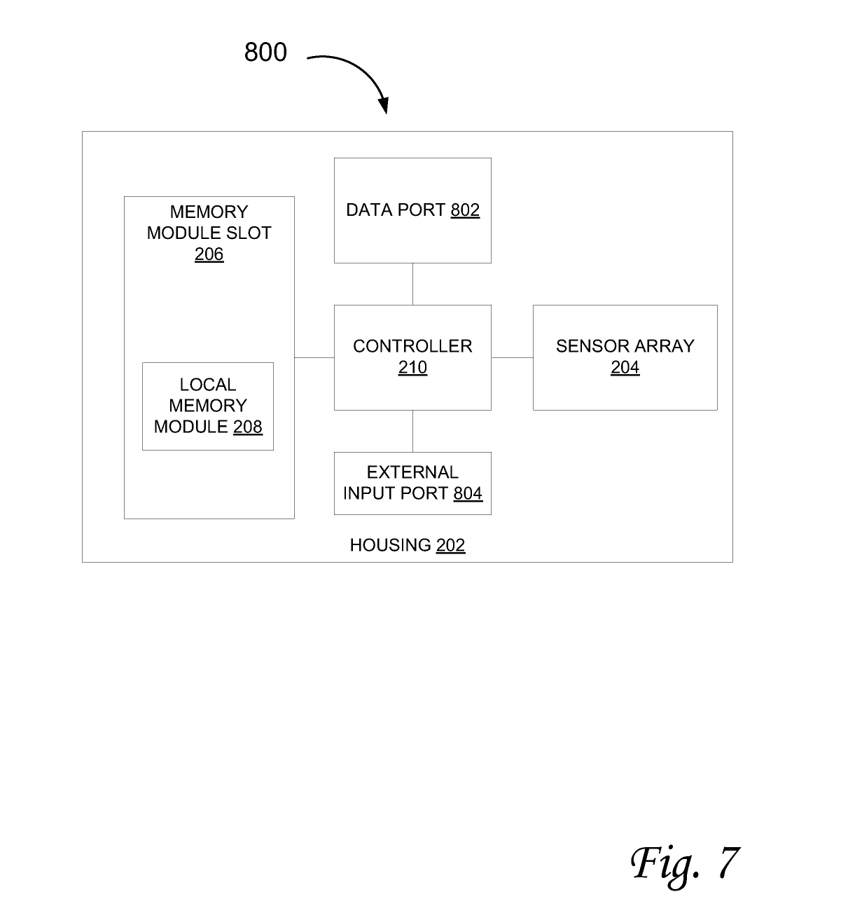

FIG. 7 is a schematic drawing illustrating a motion dynamics recorder including a data port for streaming data to an external device, according to some embodiments of the present invention. The motion dynamics recorder 800 includes the same components as the motion dynamics recorder 200 of FIG. 2. However, motion dynamics recorder 800 further includes a data port 802, for connecting the motion dynamics recorder 800 to an external device, and for streaming data to the external device. Optionally, an external input port 804 is also present, for receiving an external analog and/or digital input from an external sensor and for writing the input to the local memory module 208. To be more specific, the data port 802 is connected to the controller 210, and the data is streamed from the controller 210 to an external device connected to the data port 802. Similarly, the external input port 804 is connected to the controller 210 from an external sensor connected to external input port 804 is received by the controller 210.

In a variant, the external device is a display instrument for real-time information, such as a moving navigation map, or an artificial horizon. Alternatively, the external device is data transmission equipment for linking real-time tracking data to internet databases. Optionally, the data port 802 may be connected to a computing unit 500 in order to bench test the motion dynamics recorder 800, before the motion dynamics recorder 800 is installed on a vehicle. In this case, the computing unit 500 would need to have virtual computer terminal software installed in order to visualize messages sent from the controller 210 and in order for the user to enter commands to the controller 210 from the computing unit's keyboard.

The presence of external imput port 804 allows the motion dynamic recorder 200 to record data generated from measurements, which cannot be taken by the sensor array 204. Digital inputs may include, for example, signals from switches indicating that the landing gear is up or down, that the flaps are closed or extended, and that a door is open or closed. An exemplary analog input is an analog signal from a sensor measuring engine exhaust temperature.

In a variant, the external device is connected to data port 802 through a digital connection. For example, the data port 802 may be a Recommended Standard RS-232 port or a USB port.

In another variant, firmware in the external device may be updated through the motion dynamics recorder 800. This is accomplished by inserting a setup module, as described in FIG. 4, in the motion dynamics recorder 800. The setup module contains firmware updates for the external device. The firmware update is received by the controller 210, and streamed through the output port 802 to the external device. The external device receives the firmware update and updates the external device firmware, according to instructions stored on the setup module.

Optionally, when the motion dynamics recorder 800 is operating, data is continuously streamed through the data port 802, even if no local memory module 208 is in the memory slot 206 and/or if no remote memory module is 304 connected to the motion dynamics recorder.

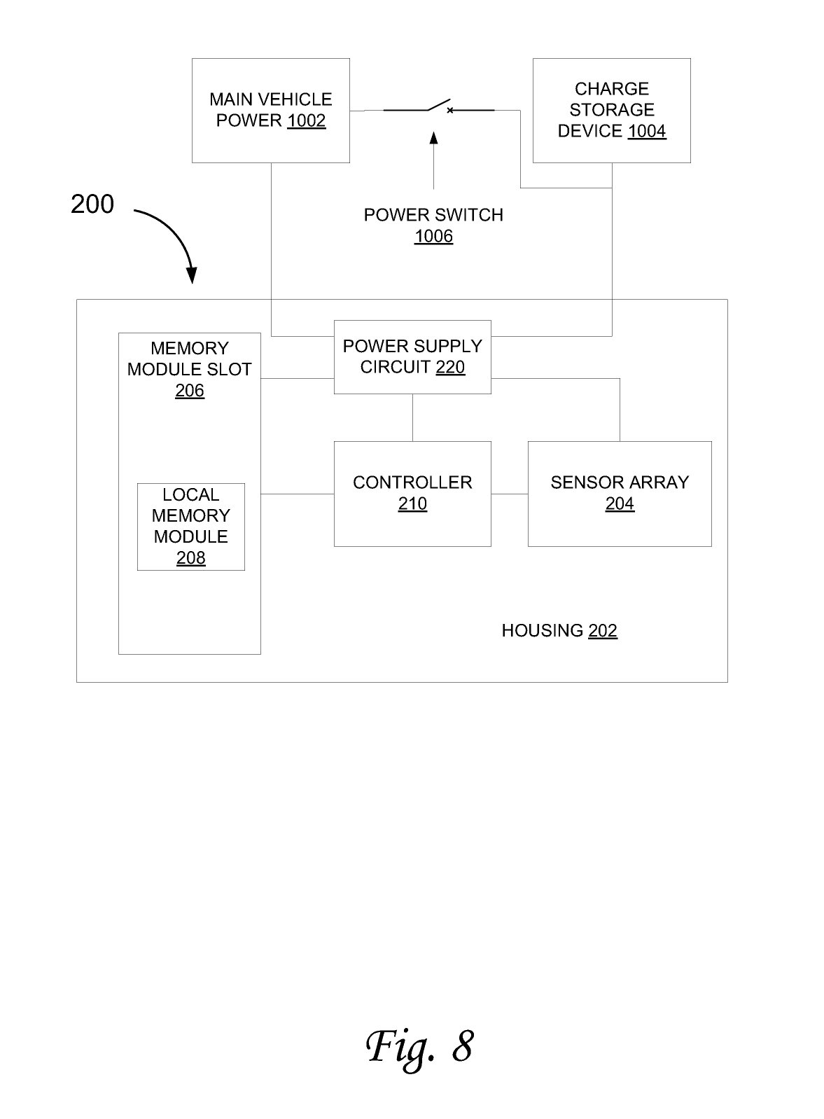

FIG. 8 is a schematic drawing illustrating a motion dynamics recorder connected to a vehicle's main power bus, and optionally to a charge storage device, according to some embodiments of the present invention. In FIG. 8, the controller 210, the memory module slot 206 and the sensor array 204 all receive power from a power supply circuit 220 that is connected to the vehicle's main power bus 1002 and optionally to the vehicle's charge storage device 1004.

The main vehicle power bus 1002 is the main source of electrical power for the vehicle and receives power from the charge storage device 1004 through the main power switch 1006. Normally, the charge storage device 1004 is a battery that is charged by means of a generator or alternator.

The motion dynamics recorder 200 is designed to draw power from the main vehicle power bus 1002, unless the main vehicle power 1002 is turned off while the motion dynamics recorder 200 is actively logging data. If the main vehicle power is turned off during logging, the motion dynamics recorder 200 draws power from the charge storage device 1004 until logging activity ceases, at which time the power supply circuit 220 internally disconnects from the charge storage device 1004, causing the motion dynamics recorder 200 to power down. This ensures that the motion dynamics recorder 200 continues to log data until vehicle motion ceases even though vehicle power may be switched off or accidentally lost. If the vehicle is an aircraft, an abrupt loss of operation of the main vehicle power 1002 may brought about by a damaging maneuver or a vehicle crash, when it is important that data be written on a memory module, for after-the-fact analysis.

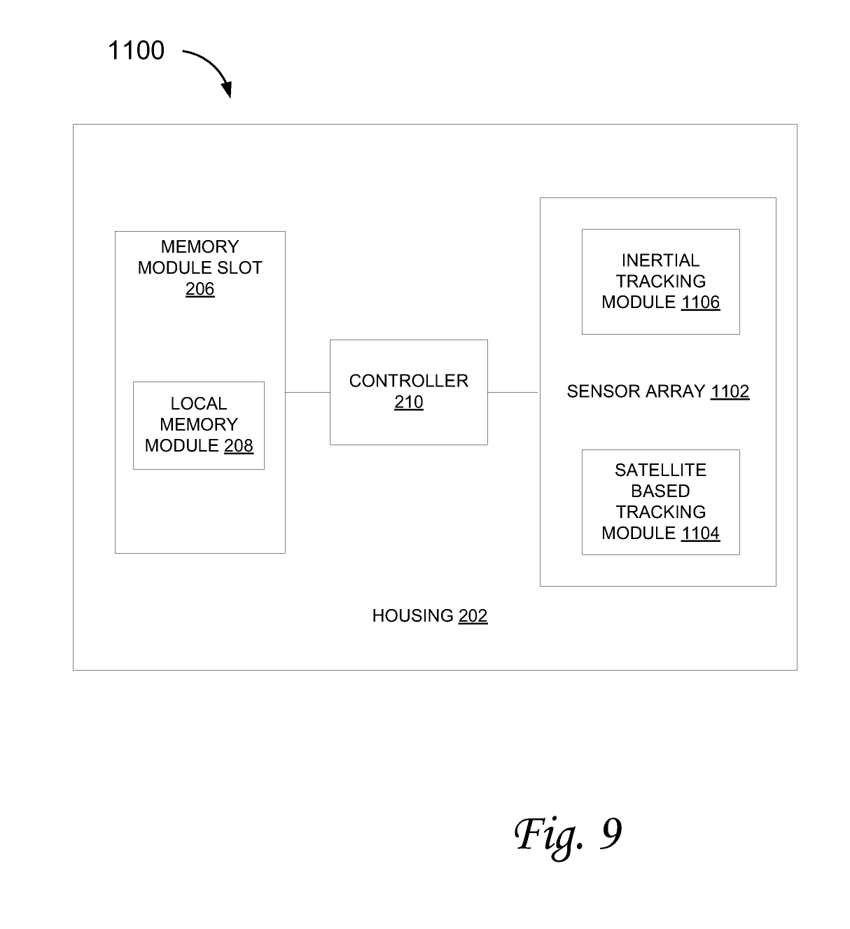

FIG. 9 is a schematic drawing illustrating a motion dynamics recorder, which includes an inertial tracking module and a satellite based tracking module as part of the sensor array 1102, according to some embodiments of the present invention. Motion dynamics recorder 1100 is an exemplary embodiment of motion dynamics recorder 200 of FIG. 2. In this embodiment, sensor array 1102 includes a satellite based tracking module 1104 and an inertial tracking module 1106. In other embodiments, the inertial tracking module 1106 is not present, and position tracking relies on the satellite based tracking module 1104.

The satellite based tracking module 1104 includes an antenna (not pictured), which allows communication between the motion dynamics recorder 1100 and satellites, and provides a tracking of the vehicle's motion. Optionally, the satellite based tracking module 1104 is a global positioning system (GPS) receiver. The inertial tracking module 1106 includes sensors, which measure inertial properties, such as acceleration and rotation. Sensors included in inertial tracking module 1106 may be, for example, accelerometers and rotation sensors. Optionally, three accelerometers and three rotation sensors are present, to measure acceleration and rotation for all three Cartersian axes.

In a variant, data from the satellite based tracking module 1104 and the inertial tracking module 1106 is combined into a single motion track, hereafter referred to as the “combined track”. The combined track is determined by combining a motion track based on a measurement from the inertial tracking module and a motion track based on a measurement from the satellite based tracking module. The two motion tracks are each assigned a specific weighting factor, then weighted according the weighting factors, and finally combined into the combined track. The accuracies of the inertial position fixes and of the satellite based position fixes may vary during the motion of the vehicle. For example, during periods of linear motion of the vehicle and reliable satellite signal, the satellite based motion track is likely to be more accurate than the inertial motion track since the inertial motion track drifts over time. Conversely, when the vehicle is maneuvering or the satellite signal reliability is low, the inertial motion track is likely more accurate than the satellite based motion track. The values of the weighting factors are related to the accuracy of the two motion tracks.

According to some embodiments of the present invention, the combined track is composed of an average of weighted inertial motion track and weighted satellite based motion track. An inertial weighting factor (W_{I}) and a satellite based weighting factor (W_{G}) are assigned to the inertial motion track and to the satellite based motion track, respectively. W_{I} and W_{G} vary according to the accuracy of the corresponding motion track. W_{I} increases as the accuracy of the inertial motion track increases, and decreases as the accuracy of the inertial motion track decreases. W_{G} increases as the accuracy of the satellite based motion track increases, and decreases the accuracy of the satellite based motion track increases. Optionally W_{I} and W_{G} sum to unity. Optionally, the values of W_{I} and W_{G} are calculated through an algorithm, which determines the accuracy of the position fixes, according to values from measurements taken from the satellite based tracking module 1104 and the inertial tracking module 1106.

It is known in the art that a drift exists between a vehicle's actual position and the vehicle's position obtained from inertial calculations, the drift increasing with time. The combination of the two motion tracks into a combined track through weighting factors corrects for the drift, by pulling the combined track toward the satellite based motion track. Optionally, the combined track is initialized at the position indicated by the satellite based tracking module when motion tracking of the vehicle commences.

In a variant, the combined motion track may be obtained in real-time within the motion dynamics recorder 1100, so that that the combined track is recorded on one or more memory modules. Obtaining the combined motion track in real time may be useful for streaming better quality tracking data to external devices used for navigation and vehicle control.

In another variant, the combined motion track may be obtained after the fact (post processing) by the user interface software 502, using raw data from measurements by the inertial tracking module 1106 and data from measurements by satellite based tracking module 1104, recorded separately into one or more memory modules.

Optionally, the combined motion track is obtained within the controller 210 of the motion dynamics recorder 1100, and streamed to an external device. At the same time, the controller 210 writes raw data generated from measurements by the inertial tracking module 1106 and data generated by the satellite based tracking module 1104 on one or more memory modules. This setup allows streaming of higher quality data regarding the combined motion track to external device, while retaining the raw data for post processing.

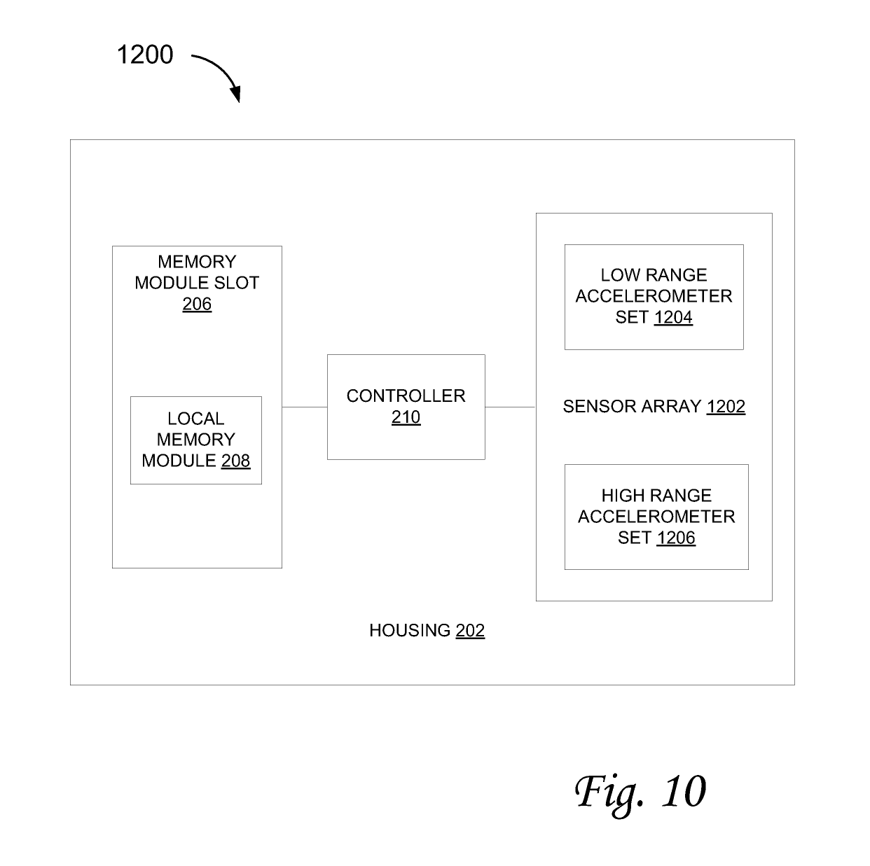

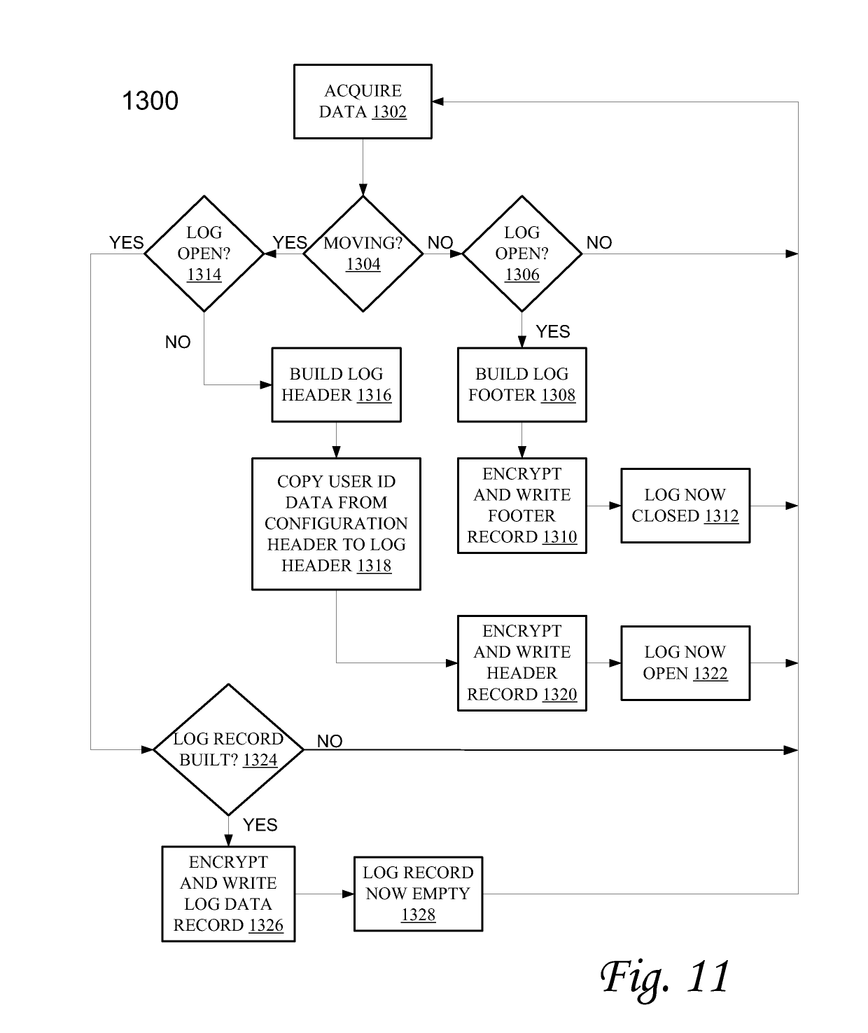

FIG. 10 is a schematic drawing illustrating a motion dynamics recorder which includes a set of low range accelerometers and a set of high range accelerometers, as part of the sensor array 1202, according to some embodiments of the present invention. The motion dynamics recorder 1200 is an exemplary embodiment of the motion dynamics recorder 200 of FIG. 2. In the embodiment shown in FIG. 11, the sensor array 1202 of the motion dynamics recorder 1200 includes a set of low range accelerometers 1204, and a set of high range accelerometers 1206. Each set may include on or more accelerometers. Optionally, each set contains three accelerometers, each accelerometer measuring acceleration along a different axis.

In the art, higher precision accelerometers are generally characterized by a lower range of measurable accelerations, and lower precision accelerometers are characterized by a higher range of measurable accelerations. In order to reduce measurement errors and in order to limit the track drift that is intrinsic to inertial measurements described above, the motion dynamics recorder 1200 is equipped with a set of accelerometers 1204 characterized by high precision, and therefore low dynamic range. However, accelerations of 50 g or more may be reached when a vehicle crashes, where 1 g is defined to be one times the acceleration of gravity at ground level. Such accelerations extend beyond the range of the low range accelerometers 1204. Therefore, optionally, the motion dynamics recorder 1200 is further equipped with a set of high range accelerometers 1206.

In a variant, the controller 210 is designed to receive measurements from a low range accelerometer, when the acceleration directed along the axis of the accelerometer is below a specific threshold. When the acceleration rises above the threshold, the controller 210 is designed to receive measurements from the high range accelerometer that is aligned with the same axis 1206. Though the threshold mainly depends on the properties of the accelerometers, the threshold is optionally set during the manufacturing of the motion dynamics recorder 1200. Alternatively, the threshold is set by a user, by reconfiguring the motion dynamics recorder 1200, according to the reconfiguration methods described above. For example, if the motion dynamics recorder 1200 is equipped with low range accelerometers 1204, which are able to measure accelerations from 0 to 10 g, and high range accelerometers 1206 which are able to measure accelerations from 0 to 50 g, the transition threshold would be at about 9 g, as measured by the high range accelerometers. The threshold is set far enough below the stated limit of the low range accelerometer, because the stated limit may not be reachable, since it is known in the art that the limits of accelerometers are not perfectly precise and may vary from one accelerometer to another.

According to some exemplary embodiments of the present invention, the motion dynamics recorder 1200 is equipped with three low range accelerometers and three high range accelerometers, in order to measure accelerations that are directed along all three vehicle axes. Exemplary low range accelerometers are manufactured by Analog Devices, Inc., and characterized by a range of 0 to 10 g and a precision of ±0.01 g. Exemplary high range accelerometers are manufactured by Analog Devices, Inc., and characterized by a range of 0 to 50 g and a precision of ±0.1 g.

FIG. 11 is flowchart illustrating a method 1300 for writing log data on a memory module, according to some embodiments of the present invention. FIG. 11 charts the main control loop of the controller 210 in FIG. 2. This chart may be understood as applying to a local memory module and/or a remote memory module.

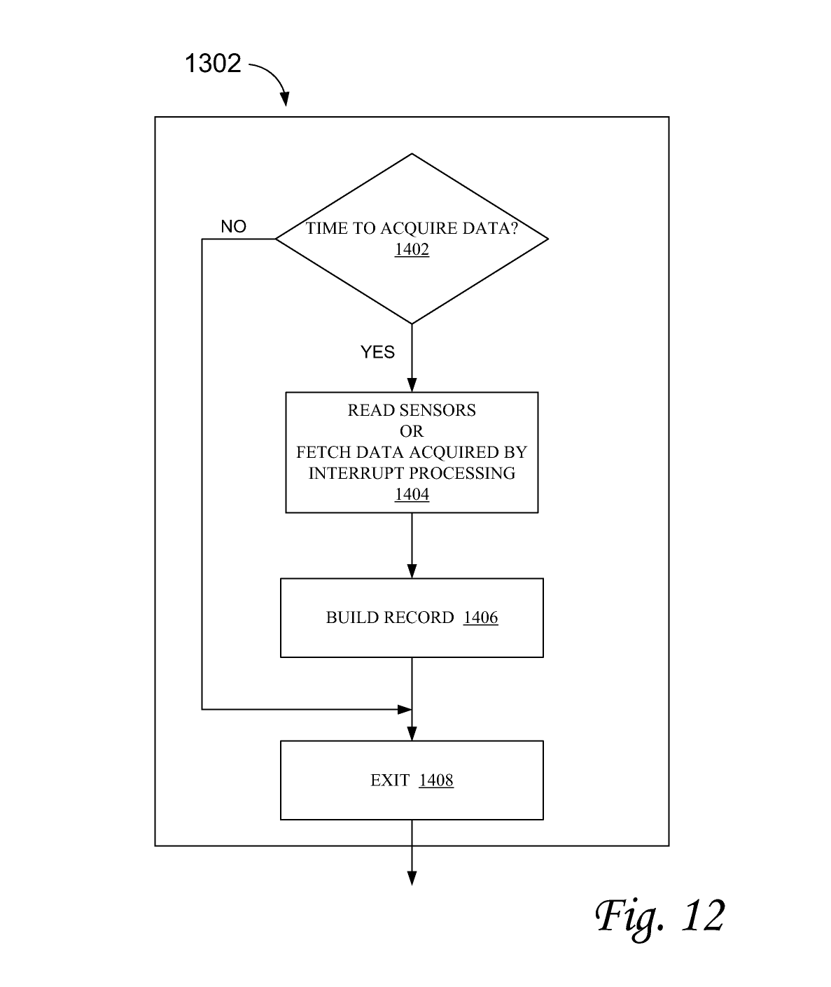

At 1302, new data to be recorded is acquired. This is further described below and in FIG. 12.

At 1304, the state of motion of the vehicle is noted, in order to decide whether it is time to open a log or close a log.

At 1306, if the vehicle is not moving, the status of the log is checked. If the log is open, steps are taken to close the log and thereby terminate further recording. At 1308, a log footer is created. At 1310, a log footer record is written on the memory module. Optionally, a log footer record is encrypted before being written, At 1312, the log is designated as closed, and control passes back to 1302, where the next round of data acquisition occurs. However, if a log is not open, no log activity occurs and control passes to 1302 where the next round of data acquisition occurs.

At 1314, if the vehicle is moving, the status of a log is checked. If the log is not open, steps are taken to open a new log and initiate the recording of data. At 1316, a log header is created. At 1318 user identification data from the configuration header of the memory module (as described above) is copied onto the newly created log header. At 1320, the log header record is written on the memory module. Optionally, the log header record is encrypted before being written. At 1322 the log is designated as open, and ready to receive new log data records, and the control passes back to 1302. However, if a log is already open, control passes to 1324.

At 1324, if a log record has been built, control passes to 1326 where the record is optionally encrypted and written to the log. At 1328 the record is designated as empty, that is void of data and awaiting new data, so that the record will not be written again until it receives new data. Finally, control passes to 1302 where the next round of data acquisition occurs. This step iterates once for each type of data record that may be written to a log. Each type of record contains a set of similar measurements; for example, inertial measurements, and satellite position measurements.

Method 1300 may be applied to a motion dynamics recorder to write on a local memory module and/or remote memory module, both of which have been described above.

FIG. 14 is a flowchart illustrating a method 1302 for acquiring data to be written to an open log. FIG. 14 illustrates the logic for a single record type and should be taken as representative of all the record types that may be written to a log. Method 1302 is a logic sequence, which is found within block 1302 of FIG. 11.

At 1402 a check of the time is made to determine if it is the proper time take a measurement. The decision depends on the sample frequency, which may be set by a user. If it is not the proper sample time, no new data is acquired and the routine exits back to the main loop 1300.

At 1404, the time is right for acquiring the next set of data and the requisite sensors are read. Alternatively, the data may be acquired asynchronously by means of interrupt routines and held for this routine to pick up.

At 1406, the newly acquired data is moved into a record buffer in the format in which it is to be written to a log.

At 1408, the data acquisition routine exits back to the main loop 1300.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be used to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof, the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether CTRL logic or other components, can be combined in a single package or separately maintained and can further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A motion dynamics recorder, comprising:
a controller;
a sensor array in communication with the controller, and configured for measuring at least one characteristic of the motion of a vehicle; and
a memory module slot for receiving a removable local memory module;
wherein the controller is configured to generate data from the measurements and to write the data to a removable memory module, when the removable memory module is inserted in the slot.

2. The motion dynamics recorder of claim 1, wherein the sensor array is further configured for measuring at least one characteristic of the environment of the vehicle.

3. The motion dynamics recorder of claim 1, further comprising:
a local housing for supporting the sensor array, the controller and the local memory module;
a remote housing located distal to the local housing; and
a remote memory module disposed in the remote housing and in communication with the controller;
wherein the controller is configured to write at least some or all of the data to the local memory module and at least some or all of the data to the remote memory module.

4. The motion dynamics recorder of claim 1, wherein the memory module slot is further configured to receive a setup module containing setup data, and the controller is configured to read the setup data and reconfigure at least one operation of the motion dynamics recorder according to the setup data.

5. The motion dynamics recorder of claim 3, wherein the remote housing is a crash resistant case.

6. The motion recorder of claim 1, wherein:
the memory module is readable by a computing unit having user interface software; and
the user interface software grants or denies access to data in the module to a user, according to an access permission scheme.

7. The motion dynamics recorder of claim 6, wherein:
each memory module is individually assignable to a combination of users, the users comprising at least an owner and optionally an instructor, and/or an operator; the user data comprising:
owner data containing a name and password:
optionally, instructor data containing a name and password;
optionally, operator data containing a name and password; and
the access permission scheme based on the user data such that:
an operator using the computing unit's user interface software is granted access only to logs that carry that operator's data, providing the operator has provided the proper password to the user interface;
an instructor using the computing unit's user interface software is granted access only to logs that carry that instructor's data, either as instructor or operator, providing the instructor has provided the proper password to the user interface; and
an owner using the computing unit's user interface software is granted access to all logs, providing the owner has provided the proper password to the user interface.

8. The motion dynamics recorder of claim 1, further comprising a port for connecting to an audio and/or visual display device, wherein the motion dynamics recorder is configured to output at least some of the data to the audio and/or visual display device in real-time.

9. The motion dynamics recorder of claim 1, wherein the motion dynamics recorder is configured to stream the data to an external device while the motion dynamics recorder is performing one or more of the following operations: measuring motion, generating data, and writing data to the memory module.

10. The motion dynamics recorder of claim 9, further configured to stream data to the external device while the motion dynamics recorder measures and generates data;
wherein the motion dynamics recorder streams data to the external device, with or without the local memory module inserted into the slot; and
wherein motion dynamics recorder streams data to the external device, with or without the remote memory module in communication with the recorder.

11. The motion dynamics recorder of claim 1, wherein the motion dynamics recorder is configured to operate within a vehicle comprising a switched power bus and an unswitched power bus, and the motion dynamics recorder further comprises two power sources, the two power sources comprising:
a switched power input connectable to the vehicle's switched power bus; and
a backup power input connectable to a charge storage device connected to the vehicle's unswitched power bus;
wherein the motion dynamics recorder is configured to draw power from the backup input when power from the switched power input is turned off while the motion dynamics recorder has open logs receiving data.

12. The motion dynamics recorder of claim 11, wherein the motion dynamics recorder is configured to automatically shut down when the vehicle main power is off, except the motion dynamics recorder is configured to remain on and draw power from the backup power input if the motion dynamics recorder is in the process of writing data to open logs on one or more memory modules and to shut off the backup power and shut down the motion dynamics recorder when the motion dynamics recorder closes the last open log.

13. The motion dynamics recorder of claim 1, wherein the motion dynamics recorder is configured to generate motion tracking data, the sensor array of the motion dynamics recorder further comprising:
an inertial tracking module for tracking the vehicle's motion using the laws of inertia; and
a satellite based tracking module for tracking the vehicle's motion using a satellite positioning system.

14. The motion dynamics recorder of claim 13, wherein the tracking data comprises:
an inertial motion track based on a measurement from the inertial tracking module; and
a satellite based motion track based on a measurement from the satellite based tracking module;
wherein the two motion tracks are weighted with weighting factors and combined into a single combined data track;
wherein the weighting factor for the inertial motion track increases as the satellite based component becomes less accurate than the inertial motion track, and the weight factor for the satellite based component increases as the inertial motion track becomes less accurate than the satellite based motion track.

15. The motion dynamics recorder of claim 1, wherein the sensor array comprises:
a set of low range accelerometers with high resolution for taking acceleration measurements along at least one of the vehicle's axes when the acceleration of the vehicle along the axis is below a specific threshold; and
a set of high range accelerometers with low resolution for taking acceleration measurements along at least one of the vehicle's three axes when the acceleration of the vehicle along the axis is over the threshold.

16. The motion dynamics recorder of claim 15, wherein each set of accelerometers comprises three accelerometers for taking acceleration measurements along the vehicle's three axes, each accelerometer operating independently of the others.

17. The motion dynamics recorder of claim 1, wherein the data is written at a variable data logging rate.

18. The motion dynamics recorder of claim 17, wherein the motion dynamics recorder is configured to:
increase the data logging rate when the motion dynamics recorder senses that the vehicle is maneuvering, to provide data which describes the vehicle's motion at a greater resolution; and
decrease the data logging rate when the motion dynamics recorder senses that the vehicle is not maneuvering, for conserving storage space on the local memory module.

19. The motion dynamics recorder of claim 1, wherein the local memory module is hot swappable with other memory modules during operation of the motion dynamics recorder.

20. The motion dynamics recorder of claim 1, wherein the motion dynamics recorder is configured to write the data to a single file on the memory module, wherein the file occupies the total storage capacity of the memory module.

21. The motion dynamics recorder of claim 20, wherein the motion dynamics recorder is configured to write the data to the file on the memory module in a serial manner, wherein the data is organized in a serial manner and returns from the end of the file to the beginning in a cyclical manner with individual motion logs juxtaposed and contiguously arranged.

22. A system for recording vehicle data logs and associating vehicle data logs with one or more personnel operating the vehicle, comprising:
one or more local memory modules, each configured with user identification data indicative of personnel in the vehicle and/or owning the vehicle; and
a vehicle data recorder, comprising a memory module slot configured to receive at least one local memory module;
wherein the vehicle data recorder is configured to write and store a log containing vehicle data to the memory modules; and
wherein the system is configured to copy the user identification data from local memory module to the log, thereby identifying individual logs with the users of the vehicle.

23. The system of claim 22, further comprising:
a first housing for supporting the vehicle data recorder and a local memory module;
a remote housing located distal to the first housing; and
a remote memory module disposed in the remote housing and in communication with the vehicle data recorder;
wherein the system is configured to copy the user identification data from the local memory module to both the local and remote logs, and the system is configured to copy user identification data from the remote memory module to both the local and remote logs, thereby identifying individual logs to users of the vehicle.

24. The system of claim 22, wherein the local memory module is assignable to a combination of users, the combination comprising one vehicle owner, optionally an instructor, and optionally an operator, by means of a specific password for each user;
the operator is provided with an operator password, which allows the operator to access logs which contain the operator's identification data;
the instructor is provided an instructor password, which allows the instructor to access logs which contain the instructor's identification data; and
the owner is provided with an owner password, which allows the owner to access all logs.
